(19) United States
(12) Patent Application Publication
(10) Pub. No.: US 2026/0133849 A1
(43) Pub. Date: May 14, 2026

(54) Network-Device-Centralized Load Balancing

(71) Applicant: MELLANOX TECHNOLOGIES, LTD., Yokneam (IL)

(72) Inventors: Noam Bloch, Bat Shlomo (IL); Miriam Menes, Tel Aviv (IL); Ran Koren, Haifa (IL); Daniel Marcovitch, Yokneam Illit (IL); Gil Bloch, Zichron Ya'acov (IL); Lior Narkis, Petah Tikva (IL)

(21) Appl. No.: 18/942,705

(22) Filed: Nov. 10, 2024

(51) Int. Cl. G06F 9/50; H04L 47/125; H04L 47/26

(52) U.S. Cl. CPC G06F 9/5083; H04L 47/125; H04L 47/26

(57) ABSTRACT

A system includes one or more processors, one or more network devices, and a controller device. The network devices are to exchange communication traffic over a network for the one or more processors, by executing work requests issued by the one or more processors. The controller device is to receive the work requests from the one or more processors and distribute the work requests among the network devices.

### TECHNICAL FIELD

The present description relates generally to network communication, and particularly to methods and systems for load balancing between network devices.

### BACKGROUND

In some communication systems, a processor or a group of processors may connect to a network using multiple network devices. One example of such a system is a Graphics Processing Unit (GPU) that connects to a network using two Network Interface Controllers (NICs) or Data Processing Units (DPUs).

### SUMMARY

An embodiment that is described herein provides a system including one or more processors, one or more network devices, and a controller device. The network devices are to exchange communication traffic over a network for the one or more processors, by executing work requests issued by the one or more processors. The controller device is to receive the work requests from the one or more processors and distribute the work requests among the network devices.

In some embodiments, the controller device is also to serve as one of the network devices, including executing one or more of the work requests. In an embodiment, the controller device is to distribute the work requests in accordance with a criterion that aims to balance a load of the communication traffic among the network devices. In a disclosed embodiment, the controller device is to maintain load estimates, which estimate respective loads of the communication traffic experienced by the network devices, and to distribute the work requests based on the estimated loads.

In some embodiments, the one or more processors are to issue the work requests by posting work descriptors on one or more queues, and the controller device is to distribute the work requests by notifying the network devices of locations from which the work descriptors are to be fetched. In other embodiments, the controller device is to distribute the work requests by forwarding the work descriptors to the network devices. Typically, the system further includes a host memory associated with the one or more processors, and the one or more queues reside in the host memory.

In an example embodiment, the controller device is to fragment a given work request into at least first and second fragments, and to provide to the network devices at least first and second work descriptors corresponding to the first and second fragments. In another embodiment, the controller device is to exchange flow-control messages with the network devices, and to distribute the work requests responsively to the flow-control messages. In some embodiments, the network devices, the controller device and the one or more processors are to communicate over a peripheral bus, and the controller device is to distribute the work requests by sending peer-to-peer messages on the peripheral bus.

In an embodiment, in executing a given work request that includes sending data to the network, a given network device is to return a completion notification to the controller network device upon sending the data. In another embodiment, in executing a given work request that includes sending data to the network, a given network device is to return a completion notification to the one or more processors. In some embodiments, the controller device is to receive completion notifications from the network devices, to reorder the completion notifications, and to provide the reordered completion notifications to the one or more processors.

There is additionally provided, in accordance with an embodiment that is described herein, a controller device including an interface and a load balancer. The interface is to receive work requests from one or more processors for exchanging communication traffic over a network. The load balancer is to distribute at least some of the work requests for execution by one or more network devices.

There is also provided, in accordance with an embodiment that is described herein, a method including receiving, in a controller device, work requests from one or more processors, the work requests requesting exchanging of communication traffic over a network for the one or more processors. The work requests are distributed by the controller device to one or more network devices. The communication traffic is exchanged over the network using the one or more network devices, by executing the work requests.

The present description will be more fully understood from the following detailed description of the embodiments thereof, taken together with the drawings in which:

### BRIEF DESCRIPTION OF THE DRAWINGS

FIG. 1 is a block diagram that schematically illustrates a computing system employing load balancing among multiple network devices, in accordance with an embodiment that is described herein;

FIG. 2 is a block diagram that schematically illustrates a computing system employing load balancing among multiple network devices for multiple host processors, in accordance with an alternative embodiment that is described herein;

FIG. 3 is a flow chart that schematically illustrates a method for load balancing among network devices, in accordance with an embodiment that is described herein; and

FIG. 4 is a block diagram that schematically illustrates a computing system that employs load balancing among multiple network devices, in accordance with an embodiment that is described herein.

### DETAILED DESCRIPTION OF EMBODIMENTS

### Overview

Various existing and emerging computing system configurations comprise a plurality of network devices, e.g., network adapters or Data Processing Units (DPUs), that together serve a processor or a group of processors. As communication rates increase, it becomes important to utilize the network devices' resources efficiently. In particular, it is important to balance the communication load among the network devices. A well-balanced set of network devices provides superior performance, e.g., high throughput, low latency, low jitter and fast completion of jobs involving multiple network operations.

Embodiments that are described herein provide methods and systems that balance the communication load among a plurality of network devices. In the disclosed embodiments, the task of load balancing is carried out by one of the network devices in the plurality. The network device responsible for load balancing is referred to herein as a “controller network device” or “controller device”. The other network devices are referred to herein as “controlled network devices” or “worker network devices”.

In a typical embodiment, a system comprises one or more host processors and multiple network devices. The network devices exchange communication traffic over a network for the host processors by executing work requests issued by the host processors. One of the network devices, which serves as a controller network device, receives the work requests from the host processors and distributes the work requests among the network devices (typically including itself). In other embodiments described herein, the controller device is a peripheral device that is responsible for distributing work requests among the network devices, but does not itself serve as a network device.

The controller network device typically maintains respective load estimates for the network device. The load estimate of a network device is indicative of the communication traffic load experienced by the network device. The controller network device distributes the work requests based on the estimated loads, typically using a criterion that aims to balance the communication traffic load among the network devices. Example techniques for load estimation that can be used for this purpose are described in U.S. patent application Ser. No. 18/638,756, entitled “Load balancing between network devices based on communication load,” which is assigned to the assignee of the present patent application and whose disclosure is incorporated herein by reference.

The controller network device may use various techniques for providing the work requests to the network devices assigned to execute them. Typically, the host processors issue the work requests by posting work descriptors on one or more queues. In some embodiments, the controller network device sends a work request to a selected network device by forwarding the corresponding work descriptor to the network device. In other embodiments, the controller network device does not forward the actual work request, but rather notifies the selected network device of the location of the corresponding work descriptor. The selected network device then pulls the work descriptor from that location.

Various associated mechanisms, such as completion notifications, flow-control and Quality-of-Service (QoS), are described herein.

### System Description

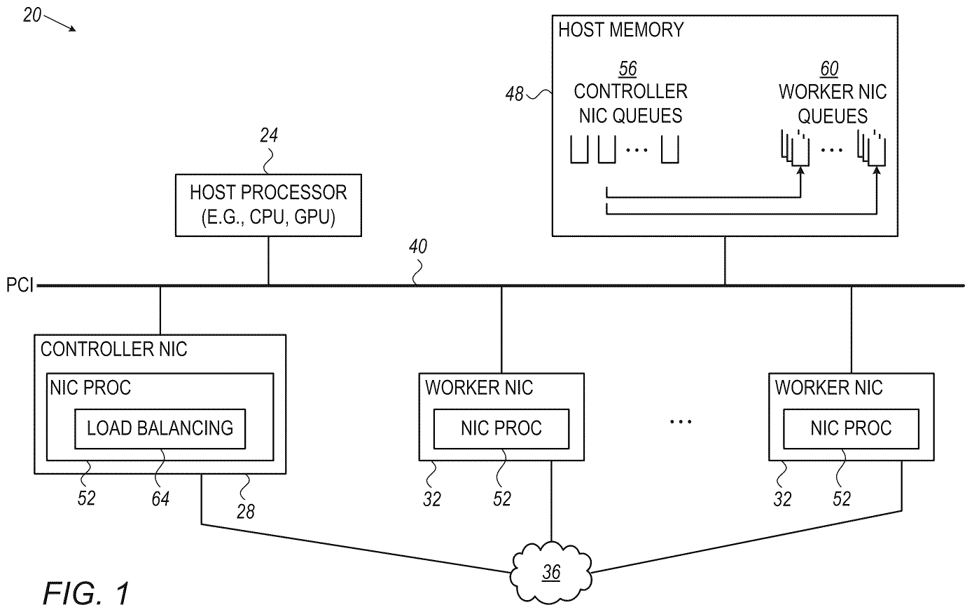

FIG. 1 is a block diagram that schematically illustrates a computing system 20 employing load balancing among multiple network devices, in accordance with an embodiment that is described herein. The network devices may comprise network adapters, such as Ethernet Network Interface Controllers (NICs) or InfiniBand™ (IB) Host Channel Adapters (HCAs). Alternatively, the disclosed techniques can be used with other suitable types of network devices, e.g., Data Processing Units (DPUs—also referred to as “Smart NICs”), or with suitable peripheral devices such as accelerators (compression accelerators, cryptography accelerators, etc.).

In the embodiment of FIG. 1, system 20 comprises a host processor 24 and multiple NICs. One of the NICs serves as a controller NIC 28, and the other NICs serve as controlled NICs (“worker NICs”) 32. Host processor 24 uses the NICs to transmit and receive communication traffic over a network 36. Host processor 24 may comprise, for example, a Central Processing Unit (CPU), a Graphics Processing Unit (GPU), or any other suitable type of processor.

The description below refers mainly to a single host processor, for simplicity of explanation. In alternative embodiments, the disclosed techniques can be used with a group of host processors that together communicate via NICs 28 and 32. Any suitable number of NICs can be used. A minimal configuration would comprise one controller NIC and one worker NIC.

The NICs communicate with host processor 24 via one or more peripheral buses 40. In the present example, bus 40 is a Peripheral Component Interconnect express (PCIe) bus. Alternatively, any other suitable peripheral bus, e.g., NVLINK or Compute Express Link (CXL), can be used. Each NIC communicates with network 36 using one or more network ports 44. Further alternatively, any of the NICs may be connected to host processor 24 by a direct connection, i.e., not via a peripheral bus.

System 20 further comprises a host memory 48, e.g., a Dynamic Random Access Memory (DRAM). Host memory 48 is accessible to host processor 24 and to NICs 28 and 32. Among other uses, host memory 48 is used for maintaining various queues, as described in detail below.

Each NIC typically comprises a host interface for communicating with host processor 24 over bus 40, and one or more network interfaces for communicating with network 36. Each NIC further comprises a memory for storing any relevant data, and a NIC processor 52 that carries out the various processing tasks of the NIC.

In some embodiments, the various NICs of system 20 are similar, or identical, in their physical implementation. The designation of a certain NIC to serve as a controller NIC 28 or as a worker NIC 32 is a logical assignment. In other words, in some embodiments each NIC in the system can be assigned to serve as a controller NIC 28 or as a worker NIC 32. The assignment can be changed over time.

In controller NIC 28, NIC processor 52 maintains one or more queues 56, referred to herein as “controller NIC queues” or “main queues”, in host memory 48. Main queues 56 are the queues on which host processor 24 posts work descriptors upon issuing work requests to the NICs. In controller NIC 28, NIC processor 52 runs a load balancing module 64 that carries out load balancing as described below.

In each worker NIC 32, NIC processor 52 maintains one or more queues 60, referred to as “worker NIC queues” or “worker queues”, in host memory 48. Queues 60 are used for queuing work descriptors that are assigned to the specific worker NIC. Assigning a work request to a given worker NIC is typically performed by transferring a work descriptor from main queues 56 to worker queues 60 of the worker NIC. Queues 56 and 60 are also referred to herein as Work Queues (WQs).

In the present context, the term “work descriptor” refers to a data item that is posted on a work queue in response to a work request. In a typical, although not limiting, example, a work request is generated by an application, and a corresponding work descriptor is posted on a work queue by a software driver associated with the network device. A work descriptor may comprise, or point to, any suitable information relating to the work request to be performed. Such information may comprise, for example, the type of operation to be performed, related addresses, data, metadata, and/or any other suitable information. Pulling a work descriptor from a queue, by a network device, typically involves reading the work descriptor.

In the present example, main queues 56 and worker queues 60 are stored in host memory 48. Alternatively, main queues 56 and/or worker queues 60 may be stored in any other suitable location.

When system 20 comprises multiple host processors 24, each host processor 24 typically has its own set of main queues 60. More generally, however, the disclosed techniques can also be used in schemes in which different host processors 24 can post work descriptors on a given main queue 60.

In a typical embodiment, host processor 24 issues Work Requests (WRs) to the NICs by posting Work-Queue Elements (WQEs) on main queues 56. A WQE may request the NICs, for example, to perform a Remote Direct Memory Access (RDMA) WRITE transaction that writes certain data to a remote memory across network 36. As another example, the WQE may request the NICs to perform an RDMA READ transaction that fetches certain data from a remote memory across network 36. Other suitable types of WQEs (e.g., SEND) can also be used.

The embodiments described herein refer mainly to WQs and WQEs, by way of non-limiting example. The disclosed techniques can be used with any other suitable types of queues and work descriptors. Thus, in the present context, the terms “WQ” and “WQE” are regarded herein as examples of queues and work descriptors, respectively. Although some of the terminology in the following description is commonly used in InfiniBand™ (IB) networks, the disclosed techniques are in no way limited to any specific communication protocol or network type.

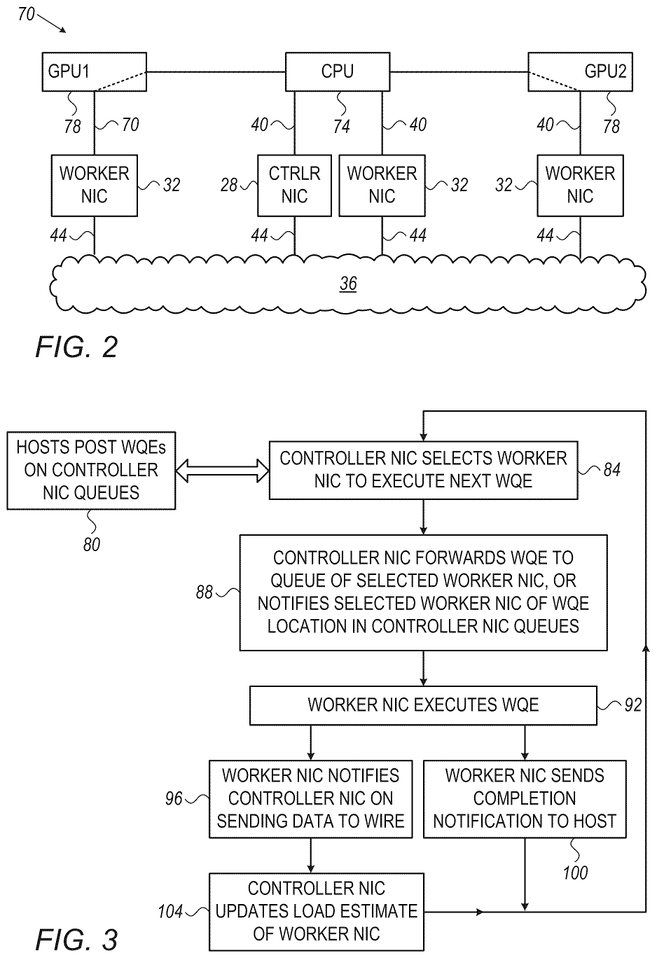

FIG. 2 is a block diagram that schematically illustrates a computing system 70 employing load balancing among multiple network devices for multiple host processors, in accordance with an alternative embodiment that is described herein. System 80 comprises three host processors, in the present example a CPU 74 and two GPUs 78 denoted GPU1 and GPU2. The host processors are served by a total of four NICs—A controller NIC 28 and three worker NICs 32.

In the present example, CPU 74 is connected by suitable communication interfaces to GPU1 and GPU2. One worker NIC 32 is connected to GPU1 by a PCIe link 40. controller NIC 32 and another worker NIC 32 are connected to CPU 74 by two respective PCIe links 40. The remaining worker NIC 32 is connected to GPU2 by a fourth PCIe link 40. Given this physical connectivity, CPU 74 is able to exchange communication traffic with network 32 via any of the four NICs.

As demonstrated by FIGS. 1 and 2, the phrase “a host processor exchanges communication traffic via a network adapter,” in various grammatical forms, refers both to direct and indirect physical connection between the processor and the network adapter. In the example of FIG. 2, controller NIC 28 balances the load of the communication traffic among the four NICs.

The configurations of systems 20 and 70, as shown in FIGS. 1 and 2, are example configurations that are chosen purely for the sake of conceptual clarity. In alternative embodiments, any other suitable configurations can be used.

For example, in some embodiments the system may comprise a controller device the performs the tasks of controlling NIC 28 in distributing work requests to worker NICs 32, but does not itself function as a NIC. Such a controller device is typically configured as a peripheral device on bus 40 (e.g., a PCIe peripheral device). In these embodiments, the controller device offloads host processor 24 of the task of load balancing (distributing work requests to the NICs) but does not execute work requests and does not send or receive traffic over network 36. The controller device typically comprises a processor 52 that runs a load balancer 64, and a bus interface for communicating over bus 40 with host processor 24 and with worker NICs 32.

The various elements of systems 20 and 70, including the various disclosed processors and network adapters, may be implemented in hardware, e.g., in one or more Application-Specific Integrated Circuits (ASICs) or FPGAs, in software, or using a combination of hardware and software elements. In some embodiments, certain elements of the disclosed processors and network adapters may be implemented, in part or in full, using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory. Elements that are not necessary for understanding the principles of the disclosed solution have been omitted from the figures for clarity.

### NIC-Centralized Load Balancing

FIG. 3 is a flow chart that schematically illustrates a method for load balancing among network devices, in accordance with an embodiment that is described herein. FIG. 3 shows two processes that are performed in parallel: The left-hand side of the figure shows a posting operation 80, in which host processors 24 issue WRs by posting WQEs on main queues 56. The right-hand side of the figure shows a process of distributing the WQEs among the multiple NICs (controller NIC 28 and worker NICs 32).

At a selection stage 84, load balancing module 64 of controller NIC 28 selects one of worker NICs 32 to execute a next WQE queued on main queues 56. As noted above, load balancing module 64 typically maintains a load estimate per NIC (including both the controller NIC and the worker NICs). For example, load balancing module 64 may receive indications from the various NICs, indicating the number and/or size of the WQEs pending for execution.

Generally, the load estimate may be indicative of the NIC's “outbound load” (the total amount of data that was provided to the NIC for sending to the network but not yet completed) and/or “inbound load” (the total amount of data that was requested to be read by the NIC over the network but not yet completed). Examples of mechanisms for calculating, storing and updating load estimates are described in U.S. patent application Ser. No. 18/638,756, cited above.

At a WQE transfer stage 88, load balancing module 64 transfers the WQE from main queues 56 to queues 60 of the selected worker NIC. Transfer of the WQE can be performed in various ways. For example, in one embodiment load balancing module 64 pulls the WQE from queues 56 and posts it on one of queues 60 of the worker NIC. In an alternative embodiment, load balancing module 64 sends the worker NIC a notification that specifies the location of the WQEs in queues 56. In response to the notification, the selected worker NIC pulls the WQE from queues 56 and posts it on its own queues 60. In one example, the notification specifies a {Queue Pair (QP), Consumer Index (CI)} pair. QP is an identifier of the specific queue from among queues 56. CI, also referred to as a read pointer, specifies the location in the queue from which the WQE can be read. Generally, however, any other suitable format can be used. The notifications from the controller NICs to the worker NICs, which indicate to the worker NICs that new WQEs are assigned thereto, are also referred to as “doorbells”.

In some embodiments, controller NIC 28 and worker NICs 32 communicate with one another (e.g., for transferring WQEs and returning completion notifications) using peer-to-peer communication over peripheral buses 40. In other embodiments, controller NIC 28 and worker NICs 32 communicate with one another over a dedicated peer-to-peer connection (separate from buses 40) between the NICs.

At an execution stage 92, the selected worker NIC executes the WQE (i.e., executes the WR in response to the WQE). Assuming the WR involves sending data to network 36, the worker NIC sends the controller NIC a notification as soon as the data has been sent, at a sending notification stage 96. The worker NIC typically sends the notification without waiting for an acknowledgement that the data was received at the destination.

In response to the notification of stage 96, load balancing module 64 of controller NIC 28 updates the load estimate of the worker NIC in question, at a load updating stage 104. The update reflects the fact that the data was sent, and therefore the load on the worker NIC has decreased.

At a completion notification stage 100, the worker NIC sends a completion notification to the host processor that issued the WR. The method then loops back to stage 84 above for handling the next WQE queued on main queues 56.

The method flow of FIG. 3 is an example flow that is chosen purely for the sake of conceptual clarity. In alternative embodiments, any other suitable flow can be used. For example, in the flow of FIG. 3 the worker NICs send completion notifications directly to host processor 24. In alternative embodiments, worker NICs 32 sends the completion notifications to controller NIC 28, which in turn forwards the completion notifications to the host processor. In some embodiments, controller NIC 28 receives completion notifications from working NICs 32 (and possibly from itself), reorders the completion notifications, and sends the reordered completion notifications to host processor 24.

### Additional Features and Variations

### WR/WQE Fragmentation

In some embodiments, load balancing module 64 may decide to divide a certain work request into two or more fragments, and distribute the fragments to two or more different NICs for execution. Fragments may be of the same size or of different sizes, as needed. This feature is advantageous when processing large work requests that can be divided into tasks that do not depend on one another. Upon fragmenting a work request into two or more fragments, module 64 typically generates a respective WQE for each fragment, and posts each WQE on a queue 60 of an appropriate NIC.

### Flow Control

In some embodiments, load balancing module 64 exchanges flow-control messages with NIC processors 52 of the various worker NICs 32. The flow-control messages enable module 64 to decide whether (and how much) free resources are available in a certain worker NIC for handling new work requests. Module 64 may distribute new WQEs to the worker NICs in response to the flow-control messages. Any suitable flow-control mechanism, e.g., credit mechanisms or pause-resume mechanism, can be used for this purpose.

### Quality-of-Service (QoS)

In a typical implementation, controller NIC 28 maintains multiple queues 56 that may each have pending WQEs. In some embodiments, NIC processor 52 of controller NIC 28 chooses which of queues 56 to serve, in accordance with a defined Quality-of-Service (QoS) criterion. In other words, the controller NIC serves queues 56 while ensuring both QoS and load balancing.

In an example embodiment, the controller NIC first uses a QoS criterion to select a queue 56 from among the queues 56 having pending work descriptors, and then chooses a worker NIC to execute a WQE from the selected queue 56. When using this order of operations (QoS decision first, load balancing decision second), work is not committed to a NIC until after the QoS decision has been made (i.e., a queue 56 has been chosen). As a result, better QoS decisions can be made.

Further aspects of combining load balancing with QoS are addressed in U.S. patent application Ser. No. 18/664,336, entitled “Load Balancing Between Network Devices Using Queue Sharing,” which is assigned to the assignee of the present patent application and whose disclosure is incorporated herein by reference.

### Example System Use-Case

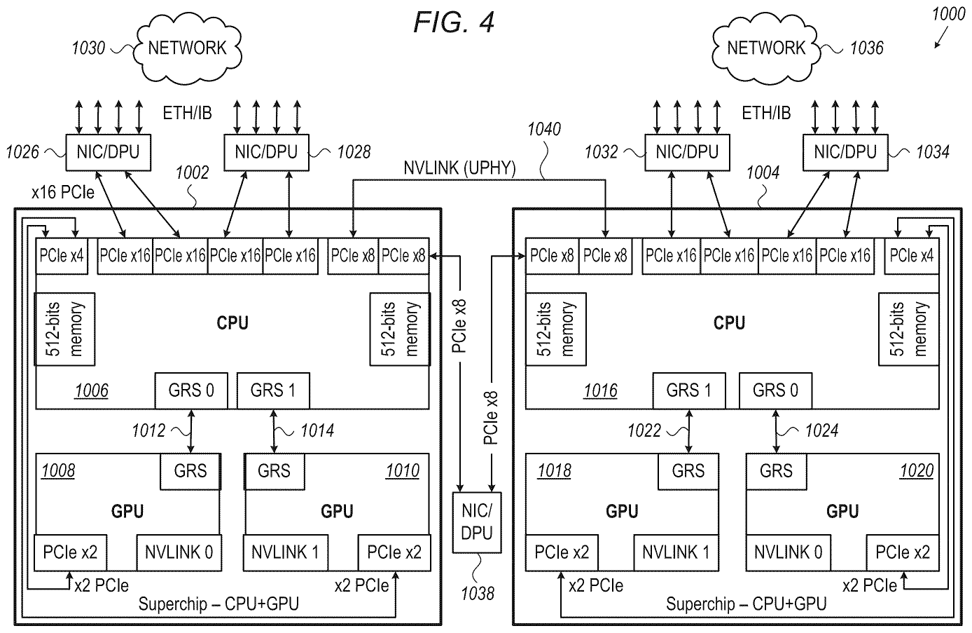

FIG. 4 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036.

The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 4 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 4, CPU 1006 is coupled to a first NIC/DPU 1026, which is coupled to a network 1030. CPU 1006 is also coupled to a second NIC/DPU 1028, which is coupled to network 1030. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 4, CPU 1016 is coupled to a first NIC/DPU 1032, which is coupled to a network 1036. CPU 1016 is also coupled to a second NIC/DPU 1034, which is coupled to network 1036. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices in system 1000, e.g., NICs/DPUs 1026, 1028, 1032 and/or 1034, may employ the disclosed load balancing techniques.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system comprising one or more processors, one or more network devices, and a controller device,
wherein the network devices are to exchange communication traffic over a network for the one or more processors, by executing work requests issued by the one or more processors, and
wherein the controller device is to receive the work requests from the one or more processors and distribute the work requests among the network devices.

2. The system according to claim 1, wherein the controller device is also to serve as one of the network devices, including executing one or more of the work requests.

3. The system according to claim 1, wherein the controller device is to distribute the work requests in accordance with a criterion that aims to balance a load of the communication traffic among the network devices.

4. The system according to claim 1, wherein the controller device is to maintain load estimates, which estimate respective loads of the communication traffic experienced by the network devices, and to distribute the work requests based on the estimated loads.

5. The system according to claim 1, wherein the one or more processors are to issue the work requests by posting work descriptors on one or more queues, and wherein the controller device is to distribute the work requests by notifying the network devices of locations from which the work descriptors are to be fetched.

6. The system according to claim 5, further comprising a host memory associated with the one or more processors, wherein the one or more queues reside in the host memory.

7. The system according to claim 1, wherein the one or more processors are to issue the work requests by posting work descriptors on one or more queues, and wherein the controller device is to distribute the work requests by forwarding the work descriptors to the network devices.

8. The system according to claim 7, further comprising a host memory associated with the one or more processors, wherein the one or more queues reside in the host memory.

9. The system according to claim 7, wherein the controller device is to fragment a given work request into at least first and second fragments, and to provide to the network devices at least first and second work descriptors corresponding to the first and second fragments.

10. The system according to claim 1, wherein the controller device is to exchange flow-control messages with the network devices, and to distribute the work requests responsively to the flow-control messages.

11. The system according to claim 1, wherein the network devices, the controller device and the one or more processors are to communicate over a peripheral bus, and wherein the controller device is to distribute the work requests by sending peer-to-peer messages on the peripheral bus.

12. The system according to claim 1, wherein, in executing a given work request that includes sending data to the network, a given network device is to return a completion notification to the controller network device upon sending the data.

13. The system according to claim 1, wherein, in executing a given work request that includes sending data to the network, a given network device is to return a completion notification to the one or more processors.

14. The system according to claim 1, wherein the controller device is to receive completion notifications from the network devices, to reorder the completion notifications, and to provide the reordered completion notifications to the one or more processors.

15. A controller device, comprising:
an interface, to receive work requests from one or more processors for exchanging communication traffic over a network; and
a load balancer, to distribute at least some of the work requests for execution by one or more network devices.

16. A method, comprising:
receiving, in a controller device, work requests from one or more processors, the work requests requesting exchanging of communication traffic over a network for the one or more processors;
distributing the work requests by the controller device to one or more network devices; and
exchanging the communication traffic over the network using the one or more network devices, by executing the work requests.

17. The method according to claim 16, and comprising executing one or more of the work requests by the controller device, including exchanging some of the communication traffic over the network.

18. The method according to claim 16, wherein distributing the work requests is performed in accordance with a criterion that aims to balance a load of the communication traffic among the network devices.

19. The system according to claim 16, wherein distributing the work requests comprises:
maintaining, in the controller device, load estimates that estimate respective loads of the communication traffic experienced by the network devices; and
distributing the work requests based on the estimated loads.

20. The method according to claim 16, wherein:
the one or more processors issue the work requests by posting work descriptors on one or more queues; and
distributing the work requests by the controller device comprises (i) notifying the network devices of locations from which the work descriptors are to be fetched, or (ii) forwarding the work descriptors to the network devices.
